(19) United States
(12) Patent Application Publication
(10) Pub. No.: US 2002/0129008 A1
(43) Pub. Date: Sep. 12, 2002

(54) Method of capturing supplemental data from a device and associating such data with user input data

(76) Inventor: Neil Hickey, Golden, CO (US)

Correspondence Address: Sam Pasternack, Choate, Hall & Stewart, 53 State Street, Exchange Place, Boston, MA, 02109, US

(21) Appl. No.: 09/802,258

(22) Filed: Mar. 8, 2001

(51) Int. Cl. G06F 7/00

(52) U.S. Cl. 707/2

(57) ABSTRACT

A method of and system for capturing and associating supplemental data with user input data. The invention employs a client device, a server computer and a network. The client device includes an identification and/or location data source, an interface program, and a first communication program, and a modified first communication program or modified interface program designed to access and to transmit requested supplemental data. The server computer includes a second communication program, a content server logically interfacing with a supplemental data server, and a modified server program designed to request and to extract the supplemental data accessed and transmitted from the client device. The network is communicatively connected to the client device and to the server computer, and transmits requests for supplemental data and transmitted supplemental data. The method includes the steps of loading the modified first communication program or modified interface program onto the client device, and the modified server program onto the server computer, thereby obtaining a modified second communication program or modified content server. Then original user data is submitted to the server computer via the modified interface program, and modified user data is obtained by placing into the original user data supplemental data from the identification and/or location data source. The modified second communication program receives the modified user data, and either the modified second communication program or the modified content server recreates the original user data and extracts the supplemental data, passing the original user data to the content server and the supplemental data to the supplemental data server.

### FIELD OF THE INVENTION

The present invention relates generally to a system for and method of capturing supplemental data from a client device and associating such data with user input data. The invention has potential application in making the use of mobile client devices more efficient and secure in an economical manner.

### BACKGROUND OF THE INVENTION

Companies are increasingly converting traditionally fixed-terminal computer services to mobile applications. For example, many shipping companies provide their field personnel with wired or wireless devices on which shipping information is entered. As company services grow progressively more mobile, security, monitoring, and tracking of personnel and product locations become vital concerns. For instance, a shipping company may want to confirm the time and location that a particular shipment was delivered. The types of mobile devices currently used, e.g., barcode scanners, cellular telephones, and the like, are often able to provide data supplemental to that provided by the user, such as an IP address, a device time, or a system location. This data can then be used to validate the identity of a user, the location of the user, the time data is entered, and other important monitoring information. Appropriate use of this monitoring information can lead to significantly improved business operations.

As business operations become increasingly mobile, it becomes important to properly validate the identity of the personnel using the mobile device. For example, a building services agency may wish to validate the identity of its inspectors whenever a building inspection report is submitted from the field in order to prevent an unauthorized user from submitting information. This practice leads to more secure operations. Current mobile systems are unable to capture data from a mobile device other than that entered directly by the user, allowing the possibility of unauthorized data entry. What is needed is a way to validate the identity of a user.

As business operations become increasingly mobile, it becomes important to properly identify the location of mobile devices and their users. For example, a shipping company may wish to validate the location of its field personnel whenever a shipment is delivered in order to confirm and record the proper shipping address. This practice leads to more accurate shipping services, and therefore high customer satisfaction. Current mobile systems can only provide information directly entered by the user, allowing the possibility of erroneous data entry. What is needed is a way to validate the location of a user.

One way to solve these problems is to utilize a customized interface program, such as a completely rewritten browser application. However, this approach is likely to be more time-consuming and expensive than the present invention. A second way to solve the same problems is to modify the client device hardware itself. For example, the hardware of cell phone could be modified to provide supplemental hardware to the cell phone provider or other companies. However, this approach would also be more expensive to implement than the present invention.

### SUMMARY OF THE INVENTION

In one aspect, the present invention is a system for extracting supplemental client device data and associating the supplemental data with user input data. This entire data message can then be transferred over a network, after which the supplemental data may be separated from the user input data. The system is comprised of a client device, a server computer and a network communicatively connected to the client device and server computer. The client device is further comprised of an identification and/or location data source, an interface program, and a first communication program, wherein a modified first communication program or modified interface program designed to access and to transmit requested supplemental data may be loaded onto the client device. The server computer is further comprised of a second communication program, a content server, and a supplemental data server. The content server is logically interfacing the supplemental data server. A modified second communication program designed to request and to extract the supplemental data accessed and transmitted from the client device may be loaded onto the server computer. Supplemental data may include hardware identification, software identification, global positioning systems data, barcode information or other information.

In another embodiment, the system may also be configured with an auxiliary data server logically interfaced with the network. The auxiliary data server may provide a portion of the requested supplemental data.

In another aspect, the present invention is a method of using a supplemental data capture system as described above to capture supplemental data from a device and associate such data with user input data. The method comprises the steps of loading onto the client device a modified first communication program or modified interface program designed to access and to transmit requested supplemental data, loading onto the server computer a modified server program designed to request and to extract the supplemental data accessed and transmitted from the client device, submitting via the modified interface program original user data to the server computer, acquiring via the modified first communication program or modified interface program supplemental data from the identification and/or location data source and placing it into modified user data, receiving via a modified second communication program the modified user data, recreating via the modified second communication program or the modified content server the original user data and extracting the supplemental data, and passing via the modified second communication program the original user data to the content server and the supplemental data via the modified second communication program or modified content server to the supplemental data server.

In a preferred embodiment, the method may further comprise the step of querying an auxiliary data server communicatively connected to the network to obtain a portion of the requested supplemental data.

The present invention allows validation of the location or identity of a remote device user based on supplemental data. The invention also provides more secure remote device business practices through the use of supplemental data, such as with mobile computer devices. The invention may also be used to provide monitoring of personnel.

### BRIEF DESCRIPTION OF THE DRAWINGS

FIG. 1 is a schematic diagram of a system for capturing supplemental data from a device and associating such data with user input data.

FIG. 2 is a flow diagram illustrating a method of capturing supplemental data from a device and associating such data with user input data.

### DETAILED DESCRIPTION

Preferred embodiments of the invention will now be described with reference to the accompanying drawings.

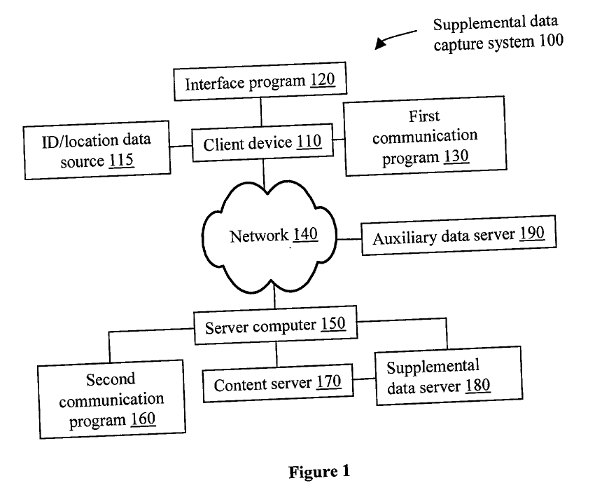

In one aspect, the present invention is a supplemental data capture system as depicted in a preferred embodiment in FIG. 1. Supplemental data capture system 100 includes a client device 110, a network 140, and a server computer 150. Client device 110 further includes an ID/location data source 115, an interface program 120, and a first communication program 130. Network 140 further includes an auxiliary data server 190. Server computer 150 further includes a second communication program 160, a content server 170, and a supplemental data server 180.

ID/location data source 115, interface program 120, and first communication program 130 are software and hardware modules resident on client device 110. Client device 110 may be any computer-controlled device, such as a PC, a browser-equipped cellular telephone, or personal digital assistant (PDA). Examples of ID location data source 115 are global positioning systems (GPS), bar code readers, etc. First communication program 130 facilitates communication between client device 110 and network 140. Network 140 may be the Internet, an intranet, a wireless network, etc.

Second communication program 160, content server 170, and supplemental data server 180 are software modules resident on server computer 150. An example of a server computer is a personal computer. Second communication program 160, content server 170, and supplemental data server 180 logically interface with server computer 150. Content server 170 logically interfaces with supplemental data server 180. Second communication program 160 provides the communication between server computer 150 and network 140. An example of content server 170 is an Apache Web server.

Auxiliary data server 190 is a software and hardware module logically interfaced with network 140. Auxiliary data server 190 may contain data such as cell phone locations. Client device 110 and server computer 150 communicate via network 140.

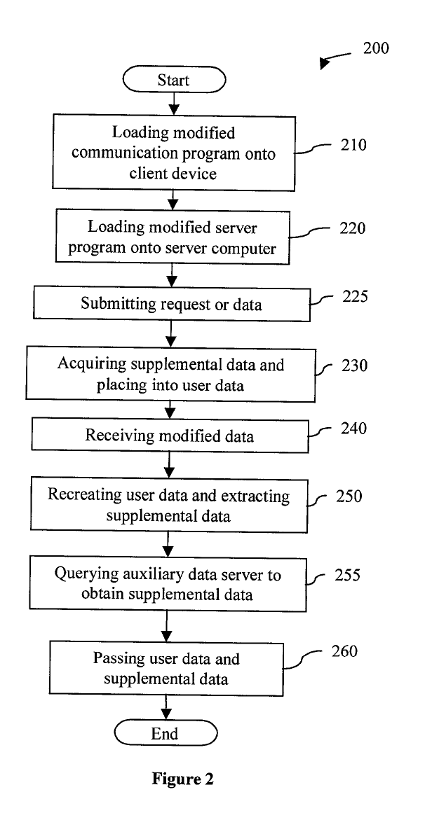

In another aspect, the present invention is a method of capturing supplemental data from a device and associating such data with user input data. A preferred embodiment of such a method is now described with reference to FIG. 2.

Step 210: Loading modified communication program onto client device

In this step, the user sets up client device 110 by loading a modified first communication program 130 or a modified interface program 120 onto client device 110. The modified program is designed to access supplemental data, such as hardware ID, software ID, GPS data, barcode information, etc. Examples of communication programs that could be modified for use in this step include browser programs (e.g., Microsoft Internet Explorer) or the IP stack itself (e.g., the Windows socket file).

Step 220: Loading modified server program onto server computer

In this step, the user loads a modified second communication program 160 onto server computer 150. This program is modified to transparently extract the supplemental data inserted by modified program 130 or 120. The modified communication program in this step corresponds to the modified communication program in step 210, that is, if the IP stack was modified in step 210, the IP stack is modified in this step. Similarly, if the Web browser was modified in step 210, the Web server program is modified in this step

Step 225: Submitting request or data

In this step, the user accesses interface program 120 and submits a request or data to server computer 150.

Step 230: Acquiring supplemental data and placing into user data

In this step, modified first communication program 130 or modified interface program 120 acquires the request or data submitted in step 225 and recognizes the data as a data request or user data submission. Modified first communication program 130 or modified interface program 120 then acquires supplemental data from ID location data source 115 and modifies the user-submitted data by adding the supplemental data to a predetermined location, for example, the http header.

Step 240: Receiving modified data

In this step, modified second communication program 160 or modified content server 170 receives the modified user data

Step 250: Recreating user data and extracting supplemental data

In this step, modified second communication program 160 or modified content server 170 recognizes the modified user data, recreates the original user data, and extracts the supplemental data inserted in step 230.

Step 255: Querying auxiliary data server to obtain supplemental data

In this optional step, software on server computer 150 queries auxiliary data server 190 to obtain supplemental data. This step may be combined with the data retrieval method described in step 250, in which a portion of the supplemental data is extracted from client device 110 and a portion of the supplemental data is extracted from auxiliary data server 190.

Step 260: Passing user data and supplemental data

In this step, modified second communication program 160 passes the original user data to content server 170. Content server 170 runs as it normally would, without regard to the supplemental data. Modified second communication program 160 or modified content server 170 makes the supplemental data available to supplemental data server 180 so that it may be passed to a host application. Alternatively, the supplemental data may be passed to a log server (not shown).

Process 200 terminates after step 260.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. A system for capturing and associating supplemental data with user input data, including:
a client device including an identification or location data source, an interface program, and a first communication program, wherein a modified first communication program or modified interface program designed to access and to transmit requested supplemental data may be loaded onto the client device;
a server computer including a second communication program, a content server, and a supplemental data server, the content server logically interfacing with the supplemental data server, wherein a modified second communication program designed to request and to extract the supplemental data accessed and transmitted from the client device may be loaded onto the server computer; and
a network communicatively connected to the client device via the first communication program and to the server computer via the second communication program, through which requests for supplemental data and transmitted supplemental data may be transmitted.

2. The system of claim 1, further comprising an auxiliary data server logically interfaced with the network, wherein the auxiliary data server may provide a portion of the requested supplemental data.

3. The system of claim 1, wherein the client device may be any computer-controlled device.

4. The system of claim 1, wherein the identification or location data source may be a global positioning system.

5. The system of claim 1, wherein the identification or location data source may be a bar code reader.

6. The system of claim 1, wherein the supplemental data may include hardware identification, software identification, global positioning systems data, or barcode information.

7. A method of using a supplemental data capture system to capture supplemental data from a device and associate such data with user input data, the supplemental data capture system including a client device further including an identification or location data source, an interface program, and a first communication program, a server computer further including a second communication program, a content server logically interfacing with a supplemental data server, and a network communicatively connected to the client device and to the server computer, the method comprising the steps of:
loading onto the client device a modified first communication program or modified interface program designed to access and to transmit requested supplemental data;
loading onto the server computer a modified server program designed to request and to extract the supplemental data accessed and transmitted from the client device, thereby obtaining a modified second communication program or modified content server;
submitting via the modified interface program original user data to the server computer;
acquiring via the modified first communication program or modified interface program supplemental data from the identification or location data source and placing it into modified user data;
receiving via the modified second communication program the modified user data;
recreating via the modified second communication program or the modified content server the original user data and extracting the supplemental data; and
passing via the modified second communication program the original user data to the content server and the supplemental data via the modified second communication program or modified content server to the supplemental data server.

8. The method of claim 7, further comprising the step of querying an auxiliary data server communicatively connected to the network to obtain a portion of the supplemental data.
